(19) United States
(12) Patent Application Publication
(10) Pub. No.: US 2012/0166425 A1
(43) Pub. Date: Jun. 28, 2012

(54) Systems and Methods for Creating and Using a Research Map

(75) Inventors: Sanjay Sharma, Mason, OH (US); John Alexander Dalessio, Brooklyn, NY (US); Jeremy Jacob Mulder, San Francisco, CA (US); Gaurav Mehra, Mason, OH (US); Molly Miller, Walnut Creek, CA (US); Mahesh Pendyala, Folsom, CA (US); Todd Joseph Frascone, Donnelsville, OH (US); Douglas N. Ritter, Centerville, OH (US); Gordon Yip, San Francisco, CA (US)

(73) Assignee: LexisNexis

(21) Appl. No.: 12/978,706

(22) Filed: Dec. 27, 2010

(51) Int. Cl. G06F 17/30

(52) U.S. Cl. 707/722; 707/736; 707/769; 707/E17.014

(57) ABSTRACT

Systems and methods create a graphical representation of a research map that allows performance of search functions using the nodes of the graphical representation. In one implementation, a system includes a processor and a memory. The memory stores instructions that cause the processor to receive a query for searching a document repository and run the query in the document repository. The processor stores the results of the query and the query as a root node in a research tree. The processor receives a filter for the results of the query. The processor stores the filter and the result list for the filter as a filter node connected to the root node of in the research tree. The processor receives a request to view a document from the result list for the filter and stores the request as a document node connected to the filter node. The processor then creates a display of a research map that includes the research tree.

### FIELD

This disclosure is generally directed to a system and method for tracking one or more searches of documents and, more particularly, to a system and method for creating a visual representation of a research trail and for performing operations on the research trail.

### BACKGROUND

Many professions require the ability to efficiently and effectively search a document repository. For example, attorneys must perform legal research, searching through many thousands of pages of court documents and decisions to determine what law may apply to the facts of a client's case, what law supports a desired outcome, and what law refutes a particular position. However, performing legal research can present several problems.

Because court opinions make up much of the law in many legal areas, it may be necessary to locate and review many court opinions to satisfactorily determine how the law applies to a particular set of facts. Furthermore, because new court decisions occur daily, common law is constantly in a state of flux. These rapid and frequent changes require a legal researcher to keep abreast of new decisions. Another legal research difficulty arises because of the jurisdictional nature of courts. For example, a decision handed down by one court does not control the law of a court in a different jurisdiction. Thus, a decision in a court outside of a jurisdiction may be helpful to a particular argument, but of little persuasive value in a target jurisdiction. In this situation, it would be helpful to find a similar court decision in the target jurisdiction.

Because of the volume of information to be searched and analyzed, especially for legal research, many products have been developed to assist attorneys and other legal researchers. Conventional legal research tools allow searching of large repositories of court cases, statutes, and other materials using search strings. These services return documents that match the search strings, allow filters to be applied to the results, and allow researchers to view documents returned in a results list. These services also provide a research trail that lists searches performed, filters applied to a search, and documents viewed. However, these research trails have drawbacks. First, the trails are presented by session, so that a researcher cannot view two research trails performed in different sessions at the same time, even if performed on the same day. Second, the trails are presented in simple text form, devoid of contextual relationship information. Third, all research activity is bundled together by session, so that research trails cannot be separated out by activity or client. The current research trail tools offer little help to a researcher attempting to determine if research is complete or to quickly identify highly relevant documents.

Therefore, it is desirable to introduce research tools to help researchers quickly determine what avenues have been searched, what documents may be highly relevant, and what additional documents may be important to those already identified as important. It is also desirable to introduce a research tool that helps organize the results of research and quickly locate and organize important documents. Finally, it is desirable to package this research, related to particular legal activities or matters, in a way that allows another researcher to quickly understand a particular research strategy and use this information to educate and/or replace the original researcher when necessary.

### SUMMARY

Disclosed embodiments provide graphical research systems and methods that help researchers visualize prior research sessions, track research progress, locate additional documents relevant to one or more searches, share their research, and determine the completeness of a research task. Disclosed embodiments may also allow a researcher to perform operations on prior searches, enhancing the researcher's ability to locate relevant documents quickly and to organize research results.

Consistent with disclosed embodiments, a method is provided for creating a research tree. The method includes receiving a query, the query specifying a search parameter for searching a document repository, executing the query to search the document repository, and storing the query and a result of the query as a root node of a research tree. The method further includes receiving a request for a first filter for the result of the query and storing the first filter and information identifying a plurality of documents matching the first filter as a filter node connected to the root node. The method further includes receiving a request to view a first document from the plurality of documents matching the first filter and storing the request to view the first document as a first document node connected to the first filter node.

Consistent with other disclosed embodiments, a system is provided for searching a document repository using a research map. The system includes a processor and a memory. The memory stores instructions directing the processor to generate information for displaying the research map. The information comprises a plurality of search or filter nodes and a plurality of document nodes representing documents. The processor receives a selection of one or more document nodes displayed on the research map. Using the selected document nodes, the processor further determines metadata values common to a majority of the documents, determines a frequency with which the metadata values occur in the documents, generates a search string using a predetermined number of the most frequently occurring metadata values, and performs a search of the document repository using the search string. The system then generates information used to display one or more documents found as a result of the search.

Also consistent with disclosed embodiments, a method is provided for searching a document repository using a research map. The method includes generating information used to display a research map. This information comprises search nodes, filter nodes, and document nodes. The method further comprises receiving a selection of a first filter or search node having a first document result list from a first research tree and receiving a selection of a second filter or search node having a second document result list from a second research tree. The method also includes determining a third result list including documents from both the first document result list and the second document result list and generating data used to display the third result list.

Consistent with other disclosed embodiments, computer-readable storage media may store program instructions that are executable by a processor to implement any of the methods, disclosed herein.

It is to be understood that both the foregoing general description and the following detailed description are exemplary and explanatory only and are not restrictive of the disclosed embodiments, as claimed.

### BRIEF DESCRIPTION OF THE DRAWINGS

The accompanying drawings, which are incorporated in and constitute a part of this specification, illustrate several embodiments and, together with the description, serve to explain the disclosed principles. In the drawings:

FIG. 1 is a diagram illustrating an exemplary graphical research map system that may be used to implement disclosed embodiments.

FIGS. 2a and 2b are diagrams illustrating exemplary research trees, consistent with disclosed embodiments.

FIG. 3 is a flow diagram illustrating an exemplary research map server process, consistent with disclosed embodiments.

FIG. 4 is a flow diagram illustrating an exemplary process used during creation of a research tree, consistent with disclosed embodiments.

FIG. 5 is an exemplary interface displaying a research map that includes a research tree, consistent with disclosed embodiments.

FIG. 6 is a flow diagram illustrating an exemplary process to find documents common to two or more nodes displayed in a research map, consistent with disclosed embodiments.

FIG. 7 is a diagram illustrating an exemplary result of an operation to find documents common to two or more nodes displayed in a research map, consistent with disclosed embodiments.

FIG. 8 is a flow diagram illustrating an exemplary process to find documents similar to selected documents, consistent with disclosed embodiments.

FIG. 9 is a flow diagram illustrating an exemplary process to generate a search string to find similar documents, consistent with disclosed embodiments.

FIG. 10 is an exemplary display of the operations that can be performed on a filter or search node of a research tree, consistent with disclosed embodiments.

FIG. 11 is an exemplary display of the operations that can be performed on a document node of a research tree, consistent with disclosed embodiments.

### DESCRIPTION OF THE EMBODIMENTS

An improved research trail may include a research map made up of one or more research trees. A research tree may track not only what search terms a researcher enters and what documents a researcher looks at, but also the relationship between the searches and the documents. Rather than storing the research trail by session or date, a research tree may be stored by a particular search or by a client number. A researcher may begin a search on one day, creating a research tree. On a different day, the researcher may view the research tree, apply filters to the search and look at documents matching the filters. The activities performed on the search may stay in the original research tree, regardless of the date performed. The research tree may provide context to a search by allowing a researcher to see how she arrived at a particular point. For example, a researcher may see what filters she applied, and in what order, to arrive at a particular document. A research map may display multiple research trees representing searches performed over several days for a particular client or research topic, providing a concise graphical view of research tasks related to a particular matter.

Research maps and research trees may enable researchers to store their searches, to retrieve and graphically display their search histories, to traverse a graphical display of the research trees, and to perform additional search operations on research trees from the graphical display. When researchers perform searches in a document repository to locate documents related to their interest using general search terms and filters, and view selected documents from the results of the search, disclosed embodiments may also allow them to perform secondary search operations based on the data from selected documents or filters.

A research map is a graphical display of searches, document views, secondary searches, and other actions taken by a researcher during one or more research sessions. A research map may be comprised of one or more research trees. A research tree tracks data about the actions taken during a particular search. As the name implies, the research tree may be organized in a tree structure, with search nodes, filter nodes, and document nodes. For example, a research tree may start with a root node, which may be a search node representing an initial search performed by the researcher. The search node may also contain a list of the documents returned as a result of the search, otherwise known as the result list. A researcher may choose to view one of the documents in the result list. A research tree may store the viewed document as a document node associated with the search node. In a tree structure, the document node may be a child node of the search node.

After viewing documents in a research tree, the researcher may choose to narrow the result list of the search with a filter. For example, the researcher may choose to limit the result list to documents created in the last 2 years, or to documents associated with a specific topic. Disclosed embodiments may create a filter node in the research tree when a filter is applied to the result list. The filter node may store the narrowed result list and may be associated with a search node. A filter node may also be associated with another filter node, for example, when a second filter is applied after the first filter. As a researcher performs more actions, a research tree may grow, creating nodes for each action performed by the researcher for a particular search.

Disclosed embodiments may create a research map showing a graphical representation of one or more research trees. The research map enables a researcher to see what searches she performed, what documents she has viewed, and what filters have been applied. A research map may show several research trees, representing searches performed over several sessions. Such a display gives a complete picture of research performed for a particular client or project. The research map may allow a researcher to limit the research trees displayed, for example, only displaying trees representing searches performed on behalf of a particular client or during a particular time frame.

The tree structures displayed on a research map enable quick comprehension of how a particular document was found, what avenues have been explored during a search, and what branches may have been missed. Such a display can also be shared with co-researchers or supervisors by, for example, printing the research tree or otherwise sharing it. The co-researcher or supervisor may then be able to quickly review the research performed to determine the completeness of the research project or to suggest further areas of research. Thus, such a tree may be used to oversee a researcher's work product for educational or performance review purposes. Furthermore, the research map allows a second researcher to quickly assume a research process should the original researcher become unavailable to continue work on the research process. The research map accomplishes this by visually displaying to the second researcher where the original researcher was in the research process.

Disclosed embodiments may also enable secondary searching based on prior searches. Nodes from two different research trees may be used to perform a secondary search. Such a secondary search may locate documents common to two or more search or filter nodes, quickly providing access to documents likely to be highly relevant to a particular line of research. In other embodiments, a researcher may select documents from one or more research trees. The metadata of the selected documents may be used to locate additional documents with similar metadata. These secondary searches may allow a researcher to easily combine the results of two lines of research and may themselves become the root node of yet another research tree.

Reference will now be made in detail to exemplary embodiments, examples of which are illustrated in the accompanying drawings. Wherever convenient, the same reference numbers will be used throughout the drawings to refer to the same or like parts.

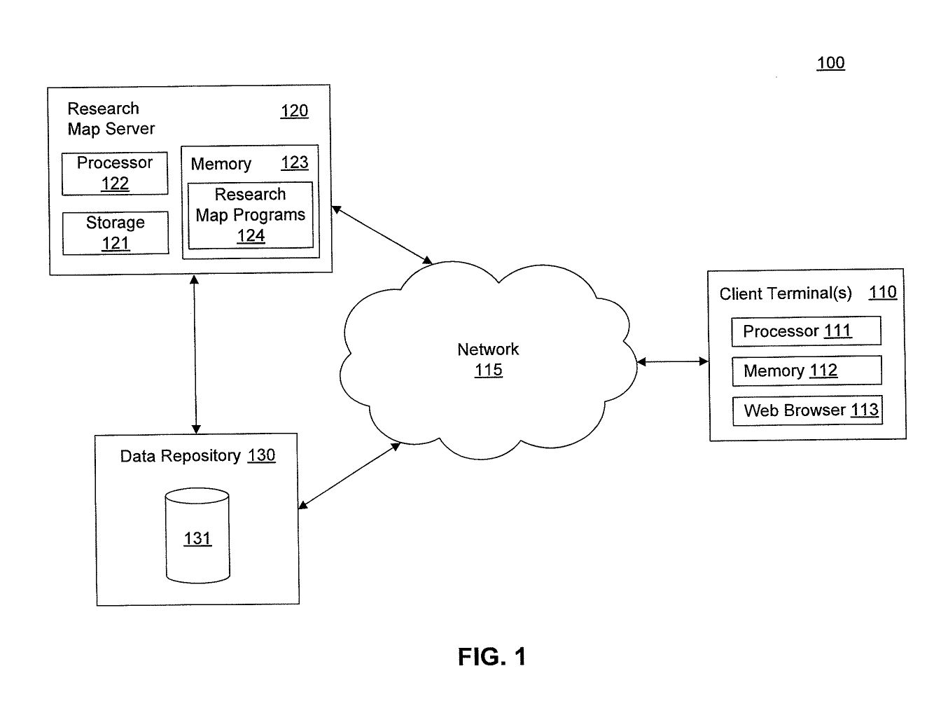

FIG. 1 is a diagram illustrating an exemplary graphical research map system that may be used to implement disclosed embodiments, including exemplary system components. The components and arrangement, however, may be varied.

Research map server 120 may include a processor 122, a memory 123, input/output (I/O) devices (not shown), and a nonvolatile storage 121. Research map server 120 may be implemented in various ways. Research map server 120 may be a general purpose computer, a server, a mainframe computer, or any combination of these components. Research map server 120 may communicate over a link with network 115. For example, the link may be a direct communication link, a LAN, a WAN, or other suitable connection. Research map server 120 may be standalone or it may be part of a subsystem, which may, in turn, be part of a larger system, such as a legacy commercial researching system.

Processor 122 may be one or more known processing devices, such as a microprocessor from the Pentium™ or Xeon™ family manufactured by Intel™ or the Turion™ family manufactured by AMD™. Memory 123 may be one or more storage devices configured to store information used by processor 122 to perform certain functions related to disclosed embodiments. Storage 121 may be a volatile or non-volatile, magnetic, semiconductor, tape, optical, removable, nonremovable, or other type of storage device or computer-readable medium. In one embodiment, memory 123 may include one or more research map programs or subprograms 124 loaded from storage 121 or elsewhere that, when executed by research map server 120, perform various procedures, operations, or processes consistent with disclosed embodiments. For example, memory 123 may include a research map generation program that creates the research tree nodes from a research session, a research map display program that creates data used to display a research map of the research tree nodes, a find common documents program that identifies documents common to one or more search or filter nodes, a find similar documents program that finds documents with metadata similar to selected documents, and an integrative support program that links the other programs and allows them to use a common database, provides a common user interface, performs basic bookkeeping tasks, (such as storing the user's input, etc.), and provides user guidance and help. Memory 123 may also include other programs that perform other functions and processes, such as programs that provide communication support, Internet access, etc.

Methods, systems, and articles of manufacture consistent with disclosed embodiments are not limited to separate programs or computers configured to perform dedicated tasks. For example, memory 123 may be configured with a research map program 124 that performs several functions when executed by processor 122. For example, memory 123 may include a single program 124 that performs the functions of the research map system, or program 124 could comprise multiple programs. Moreover, processor 122 may execute one or more programs located remotely from research map server 120. For example, research map server 120 may access one or more remote programs that, when executed, perform functions related to disclosed embodiments.

Memory 123 may be also be configured with an operating system (not shown) that performs several functions well known in the art when executed by research map server 120. By way of example, the operating system may be Microsoft Windows™, Unix™, Linux™, Solaris™, an Apple Computers operating system, Personal Digital Assistant operating system such as Microsoft CE™, or some other operating system. The choice of operating system, and even to the use of an operating system, is not critical to any embodiment.

Research map server 120 may include one or more I/O devices (not shown) that allow data to be received and/or transmitted by research map server 120. I/O devices may also include one or more digital and/or analog communication input/output devices that allow research map server 120 to communicate with other machines and devices. Research map server 120 may receive data from external machines and devices and output data to external machines and devices via I/O devices. The configuration and number of input and/or output devices incorporated in I/O devices may vary as appropriate for certain embodiments.

Research map server 120 may also be communicatively connected to one or more data repositories 130 through network 115. Data repository 130 may include one or more databases 131 that store information or documents and are accessed and/or managed through research map server 120. By way of example, the databases may be Oracle™ databases, Sybase™ databases, or other relational databases. The databases may include, for example, data and information related to court decisions, statutes, treatises, or other documents, topics associated with a document, keywords in a document, citations of a document, the jurisdiction of a document, etc. The databases may also include, for example, data and information related to research maps, such as root nodes, child nodes, document nodes, and information related to research maps, such as client-matter numbers, dates, folders, and other associated data. Systems and methods of disclosed embodiments, however, are not limited to separate databases or even to the use of a database.

Research map server 120 may also be communicatively connected to one or more data client terminals 110 through network 115. Client terminal 110 may include a processor 111, a memory 112, and a web browser 113 that enable it to communicate with research map server 120. Research map server 120 may send data to processor 111 and web browser 113, and web browser 113 may display the data as a research map. In some embodiments, research map server 120 may render the research map and send the research map to web browser 113 for display. In other embodiments, research map server 120 may send the data used to create a research map to client terminal 110 and client terminal 110 may render the research map.

Client terminal 110 may in turn send data to research map server 120 indicating selection of search, filter, or document nodes and an operation to be performed on the selected nodes. Client terminal 110 may also send search requests and selected filters and document review requests to research map server 120. Client terminal 110 may include I/O devices (not shown) to enable communication with a researcher. For example, the I/O devices may include one or more input devices, such as a keyboard, touch screen, mouse, and the like, that enable client terminal 110 to receive data from a user, such as filter parameters, search requests, requests to view documents, etc. Further, client terminal 110 may include I/O devices that communicate with one or more output devices, such as a display screen, CRT monitor, LCD monitor, plasma display, printer, speaker devices, and the like, that enable client terminal 110 to present data to a user.

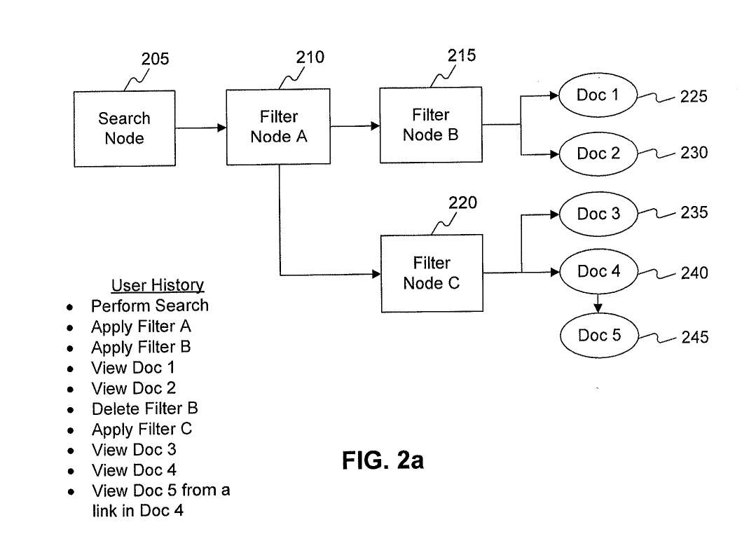

FIGS. 2a and 2b are diagrams illustrating exemplary research trees, consistent with disclosed embodiments. As shown in FIG. 2a, a research tree may begin with a search, represented by search node 205. Search node 205 may include the search request used to query a document repository. For example, search node 205 may have a search request of “adverse /2 possession,” indicating that the document repository was queried for documents where the word “adverse” occurs within two words of “possession.” Search node 205 may also contain a flag indicating whether research map server 120 should show the search node in the research map or hide the search node in the map. Search node 205 may also include a result list containing data regarding the documents found as a result of the query. The data may include the title of documents found and a link to the documents. Search node 205 may also contain a link to a parent node. As a root node, the parent of search node 205 would be empty, or null, because the root node is the first node of the research tree and has no parent. Search node 205 may also contain links to one or more child nodes. A child node is an action that occurs subsequently to the search. A child node may be a filter node or a document node. A filter node may contain an action taken by a researcher to limit the result list, such as a filter applied to the search. A document node may contain data regarding a document viewed from the result list of the search node.

For example, filter node 210 may represent a request from the researcher to limit the search results of search node 205 to only cases, thus excluding all other types of documents, such as statutes, treatises, or court filings. Filter node 210 may include the filter request. Like search node 205, filter node 210 may also include a flag indicating whether filter node 210 will appear on the research map or will be hidden. Filter node 210 may also include a result list, a link to a parent node, and one or more links to child nodes. In the example of FIG. 2a, the parent node of filter node 210 is search node 205, while the child nodes are filter node 215 and filter node 220. It is also possible for filter node 210 to have document nodes as child nodes, although this is not shown in FIG. 2a. Filter node 210 may also include a flag indicating whether it is the current node or not. A filter or search node is a current node if the researcher is working from the results list of that node.

Filter node 215 is a child of filter node 210 because, after requesting filter A, for example, a researcher may request filter B. For example, filter B may represent a request from the researcher to limit the search results to documents associated with the term “tract.” Research map server 120 may store filter node 215 as a representation of the application of filter B and, as a result of the application, may make filter B the current node. Filter node 215 may contain all the same informational fields as filter node 210, but have filter node 210 as its parent and document nodes 225 and 230 as its children. Document nodes 225 and 230 become children of filter node 210 when the researcher views the documents from the result list of filter node 215. For example, if the court decision Smith v. Jones is a document in the results list of filter B (represented by filter node 215), and a researcher views the Smith v. Jones document from the result list, research map server 120 may create a document node, such as document node 225, as a child of filter node 215 when the researcher views Smith v. Jones. Document node 230 may represent another document viewed from the results list of filter node 215.

Document node 230, and all other document nodes, may contain metadata about the document. The metadata may include one or more legal topics associated with the document, keywords used commonly throughout the document, citations to other documents located in the text of the document, a jurisdiction associated with the document, a date for the document, an author of the document, etc. If the document is a legal document, such as a court decision, document node 230 may also contain an indication of whether or not the document is still good law. The indication may be a series of colored icons, such as a red, yellow, and green shapes as a visual indication to the researcher regarding the status of the document. Document node 230 may also contain a location of the actual document to enable viewing of the document. Document node 230 may also contain a link to a parent of the document node. In the example of FIG. 2a, the link to filter node 215 is such a link. Document node 230 may also contain other information, such as a note and a flag to allow the document node to be hidden from the research map. Those of ordinary skill in the art will realize that other information not specifically mentioned may be included in document node 230.

Filter node 220 is also a child of filter node 210. In the example of FIG. 2a, filter node 220 is not a child of filter node 215 because the researcher removed filter B. For example, after looking at documents 1 and 2 a researcher may have decided that filter B (filter node 215) was not useful. In this situation, the researcher may send a request to research map server 120 to cancel this filter. In the example of FIG. 2a, this may mean that the current node changed from filter node 215 to filter node 210. When the researcher applies filter C, such as a request to limit the search results to documents also having the word “deed” in the text, research map server 120 may make the filter node representing filter C a child of the current filter node, which in the example is filter node 210. Research map server 120 may create new filter node 220 representing filter C, the “deed” filter, and may set the current node to filter node 220. Any documents viewed from the result list of filter node 220, such as documents 3 and 4, may become child nodes of filter node 220. Thus, document nodes 235 and 240 are shown as child nodes of filter node 220.

Additionally, a document node may be a child node of another document node when, for example, a researcher views a document from a link within another document. For example, if document 5 is cited in document 4, and the researcher makes a request to view document 5 by selecting a hyperlink from within document 4, research map server 120 may create document node 245 as a child of document node 240. In this way the research tree data created by research map server 120 may give context to the research trail by making it clear that document 5 was found by reading document 4 and not from the result list of filter the “deed” filter, and that the researcher tried a filter of “tract,” cancelled the filter, and instead applied a filter of “deed”.

FIG. 2b illustrates another example of a research tree resulting from the cancellation of a filter. The example of FIG. 2b begins the same as FIG. 2a, in that the research tree starts with a search for “adverse possession” (represented by search node 205), followed by application of filter A (represented by filter node 210) and filter B (represented by filter node 215). The researcher has viewed documents 1 and 2 from the result list of filter B, and filter node 215 is still the current node. However, instead of cancelling filter B, the researcher decides to cancel filter A, represented by filter node 210.

In this situation, filter node 215 must become a child of search node 205, because its parent node has been cancelled. Therefore, research map server 120 may create a new child of search node 205 using a copy of filter node 215. The new node, labeled 215′ in FIG. 2b, creates a new branch from the root node of the research tree. While filter node 215′ may retain the same child nodes as filter node 215, it may have a different result list and a different parent node. In addition, the current node changes from filter node 215 to filter node 215′. Thus, when the researcher decides to apply filter C, research map server 120 may capture this request and may add filter node 220 as a child of filter node 215′. The current node may change to filter node 220, and any documents a researcher views from the results list of filter C may become child nodes of filter node 220.

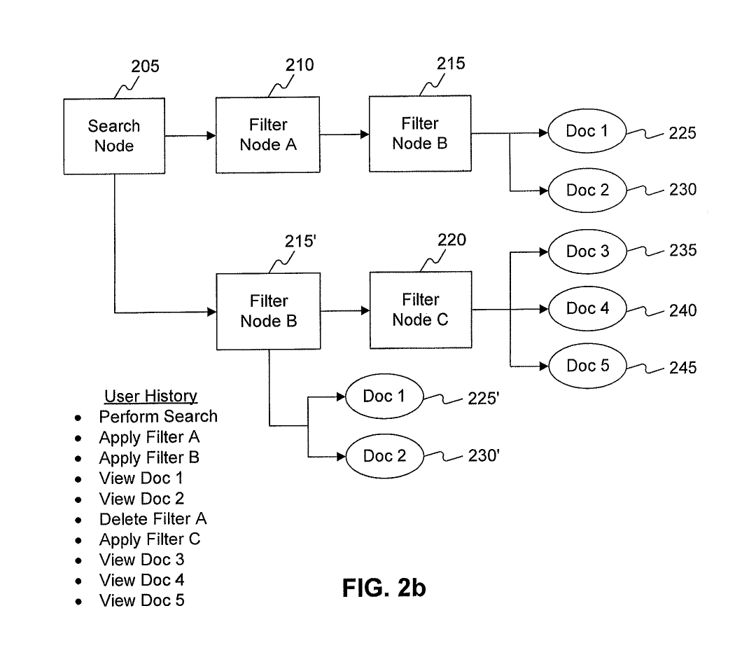

FIG. 3 is a flow diagram illustrating an exemplary research map server process 300, consistent with disclosed embodiments. This process is a high level view of how a researcher may use a research map. In certain embodiments, process 300 may be implemented according to research map program 124.

In step 305 of FIG. 3, research map server 120 may generate data to create a research map. For example, research map server 120 may generate the data by capturing the searches and filters applied by a researcher during a research session, and recording data about documents viewed by the researcher from the result lists of the searches and filters, as described above with regard to FIGS. 2a and 2b.

In step 310, research map server 120 may generate data used to create a display of a research map. A research map may display one or more research trees, with a search node as the root node of the tree. A root node is a node with no parent. Filter nodes and document nodes may be children of the root node or of other filter nodes or document nodes, as discussed above with regard to FIGS. 2a and 2b.

In step 315, research map server 120 may receive a selection of one or more nodes. For example, a researcher may select one or more document nodes from one or more research trees displayed in the research map using known techniques for selecting icons on a display, such as a left-click of a mouse in conjunction with a press-and-hold of the control key. After selecting one or more nodes from the research map, a researcher may indicate an operation to perform on the nodes. For example, a researcher may select an operation in a pop-up menu displayed when the user right-clicks on a node, or select an operation displayed when the researcher activates an icon associated with a node. In certain embodiments, the operations may be displayed in an area of the research map and be selectable directly from this location.

In step 320, research map server 120 may receive an operation selected by the researcher to perform on the selected nodes. Operations may be performed on one or more nodes. Operations that research map server 120 may perform on two or more selected search or filter nodes include finding documents common to the selected nodes. Operations that research map server 120 map perform on a selected search or filter node include loading the result list of the node, modifying the search, saving the search, expanding the documents, or hiding the node from the map. Examples of an operation that research map server 120 may perform on a selected document node include viewing the document metadata, viewing the document itself, adding the document to a folder, adding notes to the document, and viewing a citation map for the document, or finding similar documents. Research map server 120 may also perform the operation of finding similar documents on two or more selected document nodes. Finally, in step 325, research map server 120 may perform the specified operation on the selected nodes.

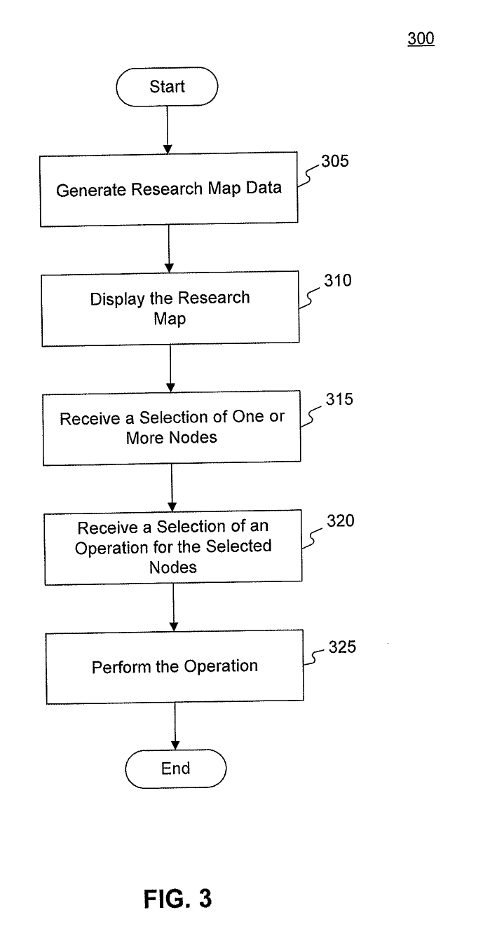

FIG. 4 is a flow diagram illustrating an exemplary process 400 used during creation of a research tree, consistent with disclosed embodiments. The process of FIG. 4 may be used during the generation of research map data, as described in step 305 of FIG. 3. Because a research tree tracks the context of a researcher's actions during a search, during creation of a research tree research map server 120 may need to organize the research tree as the researcher adds and cancels filters applied to a search. Process 400 may organize the research tree after a researcher cancels a filter.

In step 405, research map server 120 may receive a request from a researcher to cancel a filter. In step 410, research map server 120 may locate the filter node associated with the filter to be cancelled. If the filter node is located (step 415, Yes), then research map server 120 may determine if the node to be cancelled is the current node. If so (step 418, Yes), then in step 420, research map server 120 may make the parent of the node to be cancelled the current node. If the node to be cancelled is not the current node (step 418, No), then research map server 120 may determine the branch of the cancelled node that contains the current node (step 425). In step 430, research map server 120 may create a new branch, the new branch comprising the nodes on the current node branch with any of the nodes beyond the current node ignored. In step 435, research map server 120 may append the new branch to the parent of the filter node to be cancelled. Finally, in step 440, research map server 120 may set the current node to be the last filter node in the newly appended branch.

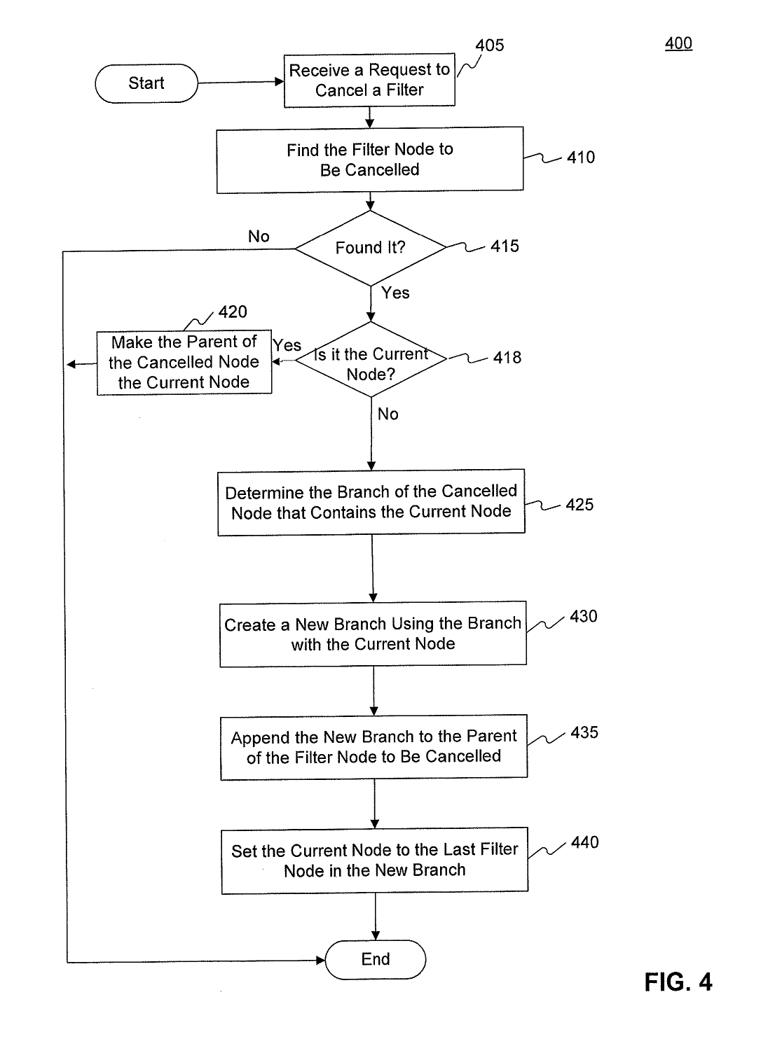

FIG. 5 is an exemplary interface 500 displaying a research map that includes a research tree, consistent with disclosed embodiments. Although FIG. 5 only displays one research tree, as explained previously, a research map may include a plurality of research trees. In a research map, each root node may represent a different research tree. In certain embodiments, a root node is always a search node and, therefore, each research tree may represent a new search. Root node 505, and other nodes, may include icon 555 that, when activated, causes research map server 120 to display operations that can be performed on root node 505. Root node 505 may contain label 525, which indicates the search string used to initiate the search. Root node 505 may also display the number of documents returned as part of the result list, as indicated by label 530.

A research tree displayed in a research map may also include filter nodes, such as filter nodes 510 and 515. Filter nodes 510 and 515 have similar features to search node 505, including icon 555, label 525, and number of documents 530. Filter nodes 510 and 515 may also include document icon 560, which indicates that the filter node has document nodes as children. Root node 505 may also include document icon 560, although this is not shown in FIG. 5. Research map server 120 may create document nodes when a researcher views a document from the result list of a filter or search node. Research map server 120 may also create a document node when a researcher views a document from a link within another document. In certain embodiments, the document nodes may be hidden from the research map until selection of an icon similar to icon 560.

A research tree displayed in a research map may also contain document nodes, such as document node 520. Document node 520 may contain a title for the document, a link to the text of the document, and icon 565. Icon 565 may cause research map server 120 to display operations that can be performed on the document node. In certain embodiments, where the documents comprise court opinions, document node 520 may also contain a flag, icon, or other visual display representing whether the opinion is considered good law, or has been overruled on at least one point of law.

A research map may also contain other elements, such as client filter 570 or date filter 575. Client filter 570 may cause research map server 120 to limit the research trees displayed to only those trees affiliated with a particular client. Date filter 575 may cause research map server 120 to limit the research trees displayed to only those trees created during a specified timeframe. In certain embodiments, a research tree may not be limited to one day or one session, as with a traditional research trail. A researcher may view a research tree days after performing the actions that created the research tree, but may still perform research activities on the research tree from the research map. For example, if a researcher using the map shown in FIG. 5, decides to go back to the “tract” filter, load the result list and perform an additional filter, these further research actions may be captured by research map server 120 and added to the research tree. Thus, filter 530 may have a child filter added to it days after the original filter was applied.

Although FIG. 5 shows a research map with one research tree, disclosed embodiments may contain several different research trees as part of a research map. For example, if a researcher performs several searches, research map server 120 may display all of the searches as research trees in display 500. Displaying multiple research trees may make scrolling necessary to view all portions of the display. Research map display 500, or portions of display 500, may also be printed. For example, research map display 500 may be printed to a PDF file and sent to another researcher or a supervisor. A researcher may select nodes in the research trees by clicking on the node, such as node 505, holding the shift or control key and clicking on another node, such as 515. Document nodes, such as node 520 may be selected in the same manner. Other known methods of selecting areas of a display may also be used.

Display 500 may include navigation functions, such as a zoom function or a pan function. For example, a research map having a plurality of research trees may be too large to legibly fit on one screen. However, should a researcher desire to view the entire research tree, the researcher may chose to zoom out. Zooming out may cause research map server 120 to render the text and icons smaller, thus allowing more nodes to be displayed on display 500. Alternatively, a researcher may choose to pan display 500 by, for example, clicking on an area of display 500 and dragging the display in any direction. This action may cause research map server 120 to drag previously un-displayed areas of the research map into display 500. These actions may allow a researcher to easily move from one research tree to another, or may allow a supervisor or another researcher to quickly evaluate the completeness of the research in a large research project.

In some embodiments, a research tree may be sent to another researcher, who may then replay the research tree. For example, if a co-researcher receives a research tree from a original researcher, the co-researcher may request that research map server 120 replay the tree in his or her own research session. When research map server 120 receives a replay request, it may run the searches and apply the filters represented by the search and filter nodes in the research tree. The co-researcher may then use the research trail to perform further research, using the research tree as a starting point. This enables the co-researcher to easily pick up where the original researcher left off.

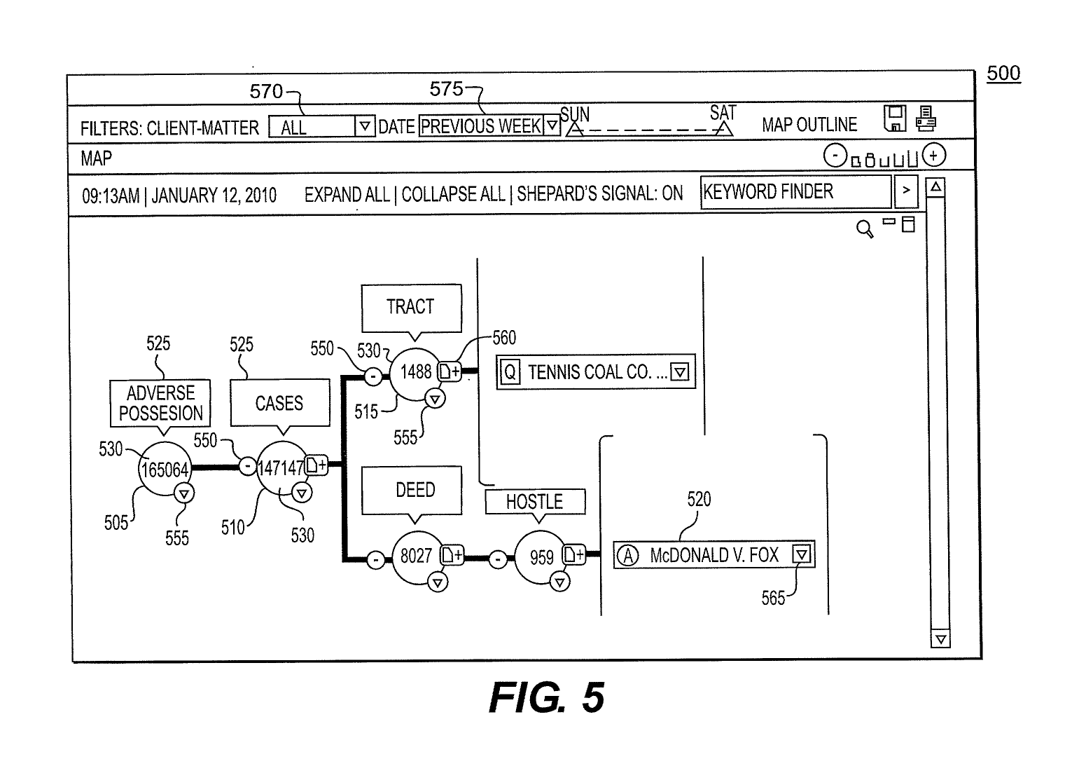

FIG. 6 is a flow diagram illustrating an exemplary process to find documents common to two or more search or filter nodes displayed in a research map, consistent with disclosed embodiments. While viewing a research map, a researcher may desire to know what documents appear in the result list of different filters or searches. Process 600 may enable a researcher to find these documents.

In step 605, and as discussed with regard to FIG. 3, research map server 120 may receive selection of two or more search or filter nodes. In certain embodiments, the search and filter nodes may come from different research trees shown on the research map. For example, a research tree starting with an “adverse possession” search and a research tree starting with a “notorious and open” search each may have several filter nodes. A researcher may select a filter node from the “adverse possession” research tree and the search node from the “notorious and open” research tree. After receiving the selected nodes, in step 610, research map server 120 may determine the documents associated with the result list of each of the selected nodes. As discussed above, the result list contains information regarding the documents matching the search and filter criteria.

In step 615, research map server 120 may determine if there are any documents common to the result list of each of the selected nodes. In step 620, research map server 120 may create a new node in the research tree. This new node may be a new root node, and it may have the common documents found in step 615 as its result list. As part of step 620, research map server 120 may also set the new root node as the current node. Next, at step 625, research map server 120 may display the common documents found in step 615.

In other embodiments (not shown), research map server 120 may determine if the selected nodes are from the same research tree or from two different research trees. If the selected nodes are not from the same research tree, then research map server 120 may create a new node in the research tree. This new node may have the root node of the research tree as its parent and contain the common documents found in step 615 as its result list. Research map server 120 may set the new node as the current node for the research tree. Finally, research map server 120 may continue at step 625 and display the common documents found in step 615.

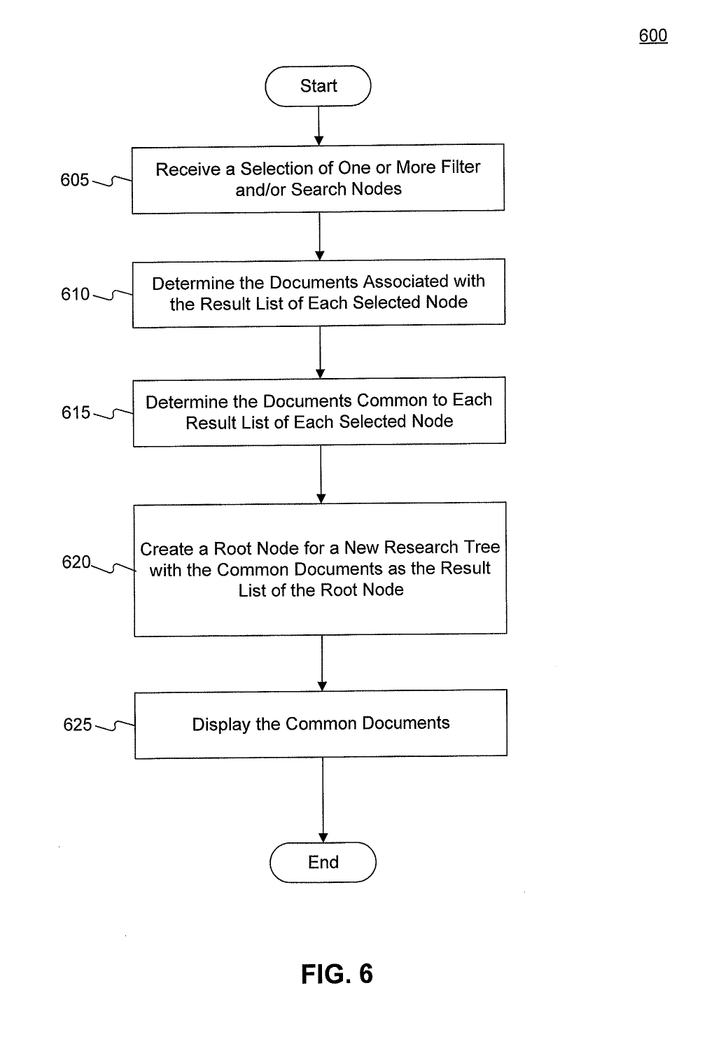

FIG. 7 is a diagram illustrating an exemplary result of an operation to find documents common to two or more nodes displayed in a research map, consistent with disclosed embodiments. In the example of FIG. 7, search node A is selected from a first research tree and filter node B is selected from a second research tree. After a researcher selects the nodes and requests a “find common documents” operation, research map server 120 may use result list 705 from search node A and result list 710 from filter node B to determine that three documents are common to both search node A and filter node B. In this case, research map server 120 may create a new root node for a new research tree having result list 715. Result list 715 contains Doc 1, Doc 8, and Doc 12, the documents common to result lists 705 and 710.

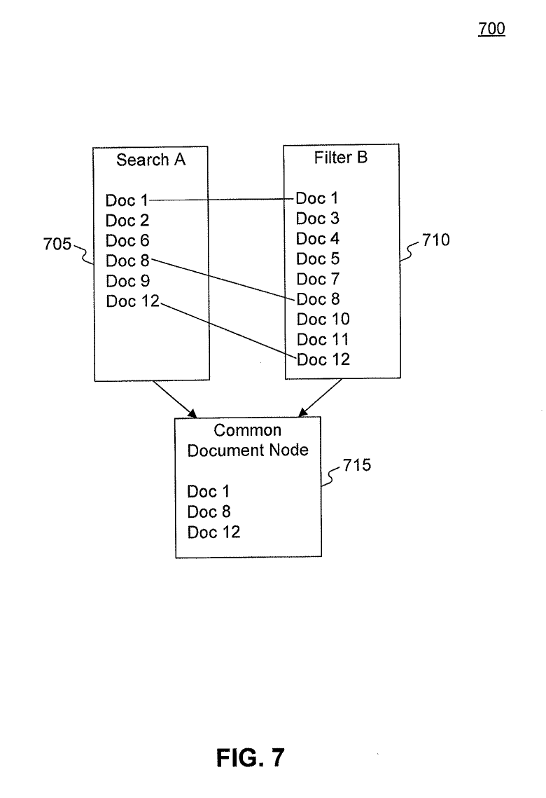

FIG. 8 is a flow diagram illustrating an exemplary process 800 to find documents similar to selected documents, consistent with disclosed embodiments. In certain embodiments, a research map may provide an operation that allows a researcher, after selecting two or more document nodes from the research map, to perform a secondary search in a document repository for documents having similar characteristics to the selected documents. For example, certain embodiments may analyze metadata associated with selected documents, and may use the metadata common to the documents to search a document repository for additional documents having the same metadata.

In step 805, and as discussed with regard to FIG. 3, research map server 120 may receive a selection of one or more document nodes. In step 810, research map server 120 may receive a threshold percentage. In certain embodiments, research map server 120 may retrieve the threshold percentage from memory 123, memory 112, storage 121. In other embodiments, research map server may receive a percentage entered by a researcher. In still other embodiments, research map server 120 may receive a default threshold percentage from electronic storage that can be modified by a researcher. For example, research map server 120 may receive a threshold percentage of 50% from storage 121 and display this percentage to a researcher. Research map server 120 may then receive a change to this threshold percentage from the researcher (e.g., changing the percentage to 75%). Research map server 120 may then save the new threshold percentage in storage 121 or memory 123 or memory 112. Research map server 120 may use the new threshold percentage in all subsequent operations for the researcher to find similar documents, or research map server 120 may use it only in the current operation.

In step 815, research map server 120 may generate a list of metadata values from different metadata categories common to a majority of the selected documents. Metadata categories may include citations to other documents found within the selected documents, legal topics, core terms, authors, and dates associated with the selected documents, or jurisdictions associated with the selected documents. Research map server 120 may determine the metadata values for the different metadata categories for the selected documents, and then may compare the values among documents to determine what values are common among the documents. Research map server 120 may use the threshold percentage to determine whether a majority of the documents contain a specific common value. For example, if five documents were selected, the threshold percentage is 50%, and three of the five documents have a core term of “lease,” then “lease” would be a metadata value common to a majority of the documents in the core term category. However, if the threshold percentage were 75%, “lease” would not be considered common to a majority of the documents. If, in this same example, four of the five selected documents were court opinions from the Northern District of California, then this jurisdiction value would be a metadata value common to a majority of the selected documents under either a 50% or a 75% threshold percentage for a jurisdiction metadata category.

Once research map server 120 has generated a list of common metadata values, in step 820, the values may be ordered by frequency within metadata category so that the most frequently occurring value has the first position in the list for the category. For example, if the core terms “gross negligence,” “wild animal,” and “duty” occur in a majority of the selected documents, with “duty” occurring a total of 75 times, “wild animal” occurring 15 times, and “gross negligence” occurring 30 times, then the ordered list for the core terms category may be “duty,” “gross negligence,” and “wild animal.” In some embodiments, when a frequency is above a predetermined threshold the core term may be considered a noise word. The frequency of a noise word may be lowered, or its weight may be decreased, so that it does not appear in a position of prominence in the list for the category.

In step 825, research map server 120 may determine whether the researcher will configure the search. If so (step 825, Yes), then, in step 830, research map server 120 may receive a selection of metadata values from the researcher. To assist in selection of metadata values, research map server 120 may display the metadata values found to be common to a majority of the selected documents by metadata category. In certain embodiments, research map server 120 may display values common to selected documents, even if not a majority of the documents, and give the researcher an opportunity to modify the threshold percentage. In certain embodiments, research map server 120 may display the metadata values by descending frequency, so that the most common metadata values in each metadata category are displayed first.

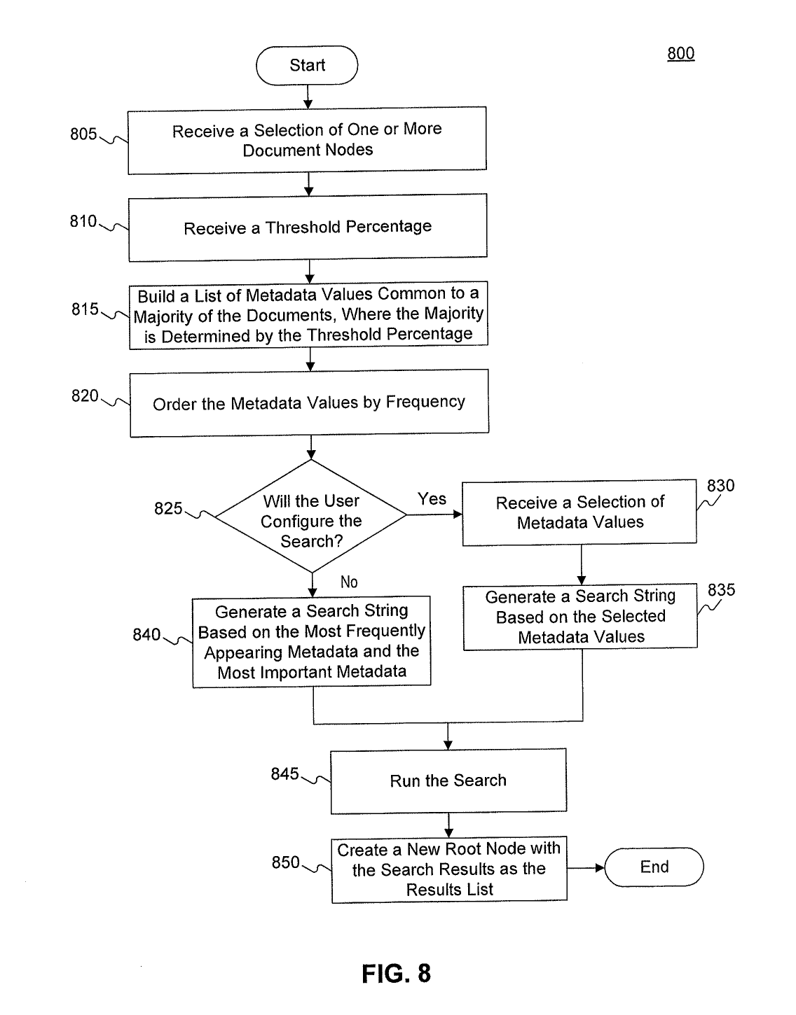

Once research map server 120 has received a selection of metadata values, in step 835, it may generate a search string based on the selected values. A search string is a group of words used to run a query in a database or other data repository. A search string contains fields to look in, the values to be searched for within those fields, and operators between the values, such as “and” and “or,” to indicate whether all values should be found in the field or only one of the values. A search string may additionally include parenthesis to indicate what operations are performed first. Creation of the search string is explained in more detail below, with regard to FIG. 9.

If research map server 120 configures the search (step 825, No), then, in step 840, research map server 120 may create the search string automatically. Without a researcher to specify selected metadata values for a search string, research map server 120 may pick the most frequent metadata values by choosing the top values from each of the ordered lists. The number of values chosen for the search string may be determined by a value stored in memory 123 or storage 112, or other electronic storage. This predetermined number, once read from electronic storage, may be modified by the researcher. Once the most frequently appearing metadata has been identified, research map server 120 may generate a search string in the manner described below, with regard to FIG. 9.

Once a search string is generated, in step 845, research map server may use the search string to run a search on a database or document repository. Finally, in step 850, research map server 120 may receive a list of documents matching the search string criteria and use this list of documents, and the search string used to find them, to create a root node for a new research tree.

FIG. 9 is a flow diagram illustrating an exemplary process 900 to generate a search string to find similar documents, consistent with disclosed embodiments. As described above, once research map server 120 analyzes the metadata of selected documents, it may search a document repository for additional documents matching the metadata of the selected documents. In order to search the document repository, research map server 120 must create a search string.

In step 905, research map server 120 may create the search string using the values selected within each metadata category. For example, research map server 120 may receive a selection of core terms of “duty” and “wild animal” from a researcher. Alternatively, research map server 120 may select the core terms of “duty” and “wild animal” because they are the most frequently occurring metadata values in the core terms category. In either case, research map server 120 may create a search string that looks for other documents with a union or intersection of the selected values. In other words, the search string may look for the core terms of “duty” OR “wild animal,” or the search string may look for the core terms of “duty” AND “wild animal.” In some embodiments, research map server 120 may use the OR operator by default. In other embodiments, a researcher may be able to change the default, either for the current search or for future searches.

In step 910, research map server 120 may apply a weight to the metadata category. The weight may represent the relative importance of a particular metadata category. For example, documents that cite to the same documents may be highly relevant and, therefore, the citation metadata category may receive a high weight value. This may mean that documents having the same citations would appear much higher in a result list. In certain embodiments, research map server 120 may limit the number of “similar documents” found to a predetermined number or less, such as 100 documents. The weight may ensure that the most important documents appear within the predetermined number.

In step 915, research map server 120 may determine if another metadata category has selected values. If another category has selected values (step 915, Yes), then steps 905 and 910 are repeated for the new metadata category, with a search string being created using the selected values. If no other categories have selected values (step 915, No), research map server 120 may continue to step 920. In step 920, research map server 120 may create a search string using the search strings created for each metadata category. If, in addition to the core terms example above, a citation to “White v. Jones” has also been selected, the resulting search string may search for documents with a core term of “duty” OR “wild animal” AND a citation to “White v. Jones.” Alternatively, the search string may search for documents with a core term of “duty” AND “wild animal” OR a citation to “White v. Jones.” As discussed above, the operators may be set by default, but may also be modified by a researcher. In some embodiments, research map server 120 may use a default of an “OR” operator between values within the same metadata category and an “AND” operator between metadata categories. In disclosed embodiments, research map server 120 may insert parenthesis around each metadata category search string, so that the search for the values in each category is performed before the intersection or union of categories.

In some embodiments, research map server 120 may include a research completeness meter that indicates by percentage how complete a research project is. Research map server 120 may determine the completeness of a research project by determining the number of tools used by the researcher. For example, the find similar tool and the find common tool, both described above, may represent tools that are available for use by a researcher. Alternatively, research map server 120 may use the number of trees in a research map or calculate the number of documents viewed as a percentage of the number of documents returned in a result list to determine completeness.

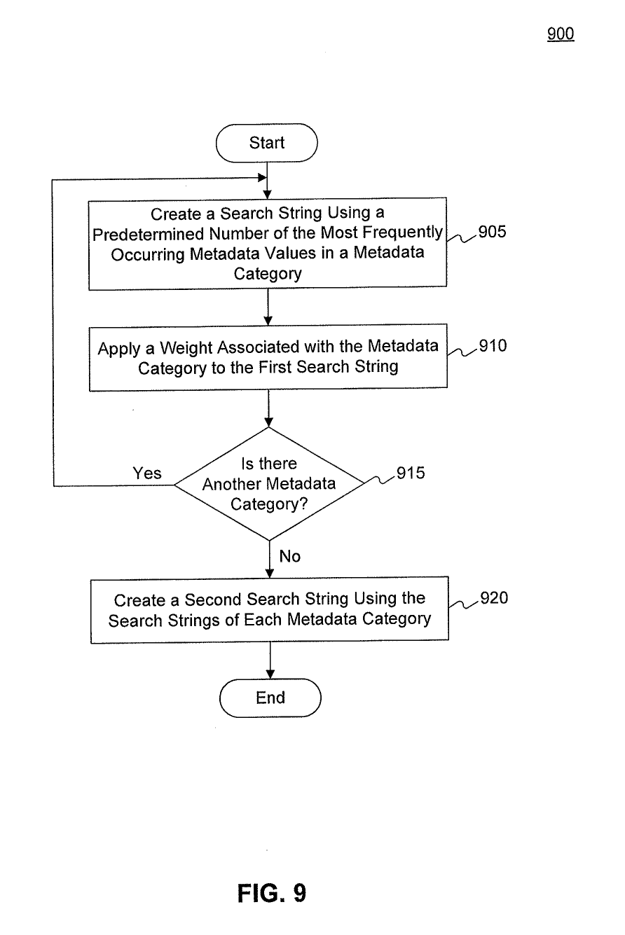

FIG. 10 is an exemplary display of the operations that can be performed on a filter or search node of a research tree, consistent with disclosed embodiments. A graphical display of a filter or search node may include icon 555 or another control that causes research map server 120 to display list 1005 of available operations for the node. A load result operation may cause research map server 120 to load the documents in the result list, so that a researcher may review the list and select one or more documents to view. Research map server 120 may cause the result list to be displayed in a window separate from the research map. A load result operation may also cause research map server 120 to mark the node as the current node for the research map.

A modify search operation allows a researcher to modify the filter or search terms associated with the node. A modify search operation may result in the creation of a new node on an existing research tree, or it may result in the creation of a root node for a new research tree. A save search operation may save the search and filters applied to the node, so that the search may easily be re-run at a later date. The search and filters applied to the node may include the search terms and filters of all parent nodes as well as the search terms and filters of the selected node. The search may be stored in memory 112, storage 121, memory 123, or some other electronic memory accessible by research map server 120.

The expand documents operation may cause research map server 120 to display the document nodes associated with the node in the research tree. Because of the number of document nodes, a research map may become crowded, so research map server 120 may hide the document nodes by default. The expand documents operation may cause these nodes to be displayed. A hide in map operation may cause research map server 120 to hide the node from the research map window. This may aid a researcher in looking at a large research map.

In addition to the operations listed in display 1005, a find common documents operation may be performed on filter and search nodes, as described above with regard to FIG. 6. This operation may be selected from a research map through a link listed adjacent to the research map, through a right-click on one of the selected links, or it may be added to list 1005 by research map server 120 when research map server 120 detects that more than one node has been selected by a researcher. One of skill in the art will understand that additional operations may be added to list 1005.

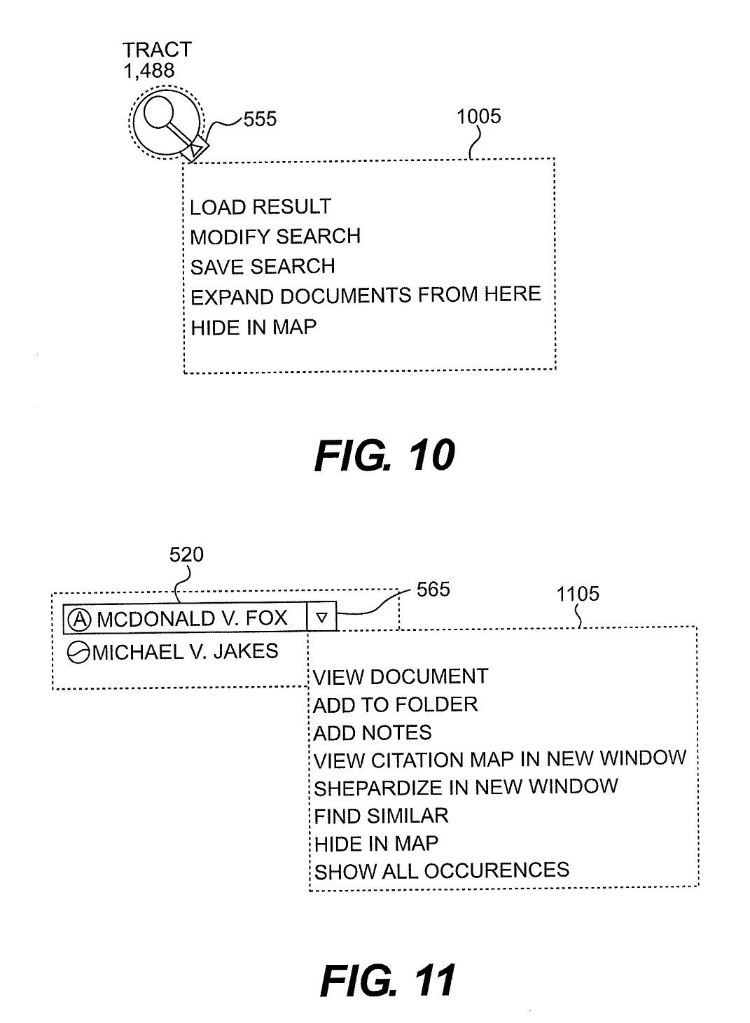

FIG. 11 is an exemplary display of the operations that can be performed on a document node of a research tree, consistent with disclosed embodiments. A graphical display of a document node may include icon 565. When a researcher activates icon 565, research map server 120 may display list 1105 of available operations for a document node. A view document operation may cause research map server 120 to open the document so that the text can be viewed. An add to folder operation may cause research map server 120 to store the document in a folder or directory. The folder or directory may be located in memory 123, in data repository 130, in memory 112, or any other electronic storage device accessible by research map server 120. This operation may allow a researcher to organize documents as they are found.

The add notes operation may cause research map server 120 to receive information and associate it with the document node. The information may include text reflecting a researcher's notes on or thoughts about the document, a hyperlink to other information, an image file, or a sound file. This operation may also allow a researcher to associate thoughts and other ideas with a document, further assisting in the organization of a research project. The view citation map in new window operation may cause research map server 120 to open a new window that includes the different sources cited in the document, the different sources citing the document, or a combination of the two. For example, the document may cite different statutes, articles, court cases, or other documents and be cited by other court cases. These sources may be listed in a pop-up window by research map server 120. The citation map may also be known as a legal issue trail, and in some embodiments the operation may be listed in window 1105 as view legal issue trail in a new window.

If the document is a legal document, the Shepardize operation may cause research map server 120 to determine whether the document has been overruled, repealed, or is otherwise not good law and create a display showing the cases or statutes that cite the document approvingly or disapprovingly. Research map server 120 may create this display in a new window. In certain embodiments, the Shepardize operation may cause research map server 120 to create an additional node as a child of the document node. This node indicates that the Shepardize operation has been performed on the document. If a researcher adds a filter to the Shepardize display, such as indicating that only documents corresponding to a warning icon should be displayed, research map server 120 may create a filter node as a child of the Shepardize node in the research tree. If a researcher then views the documents displayed after application of the filter node, research map server 120 may then create a document node as a child of the warning filter node. Thus, research map server 120 may capture these additional research actions, displaying them as part of the research tree and providing further context on the research actions.

The find similar operation works as described above with regard to FIG. 8. The find similar operation may also be available through a link displayed with the research map, or through a right-click of a selected document node. The hide in map operation may cause research map server 120 to remove the document node temporarily from the research map. The show all occurrences operation may cause research map server 120 to modify the research map to indicate all nodes that contain the document as part of its result list. Such an indication may include a different colored node, a shaded node, or text or icons added to a node. Those of skill in the art will recognize that other operations performed on a document may be included in list 1105 in addition to those specifically discussed.

The foregoing descriptions have been presented for purposes of illustration and description. They are not exhaustive and do not limit the disclosed embodiments to the precise form disclosed. Modifications and variations are possible in light of the above teachings or may be acquired from practicing the disclosed embodiments. For example, the described implementation includes software, but the disclosed embodiments may be implemented as a combination of hardware and software or in hardware alone. Examples of hardware include computing or processing systems, including personal computers, servers, laptops, mainframes, micro-processors, and the like. Additionally, although disclosed aspects are described as being stored in a memory on a computer, one skilled in the art will appreciate that these aspects can also be stored on other types of computer-readable media, such as secondary storage devices, like hard disks, floppy disks, a CD-ROM, USB media, DVD, or other forms of RAM or ROM.

Computer programs based on the written description and disclosed methods are within the skill of an experienced developer. The various programs or program modules can be created using any of the techniques known to one skilled in the art or can be designed in connection with existing software. For example, program sections or program modules can be designed in or by means of .Net Framework, .Net Compact Framework (and related languages, such as Visual Basic, C, etc.), XML, Java, C++, JavaScript, HTML, HTML/AJAX, Flex, Silverlight, or any other now known or later created programming language. One or more of such software sections or modules can be integrated into a computer system or existing browser software.

Other embodiments will be apparent to those skilled in the art from consideration of the specification and practice of the embodiments disclosed herein. The recitations in the claims are to be interpreted broadly based on the language employed in the claims and not limited to examples described in the present specification or during the prosecution of the application, which examples are to be construed non-exclusive. Further, the steps of the disclosed methods may be modified in any manner, including by reordering steps and/or inserting or deleting steps. It is intended, therefore, that the specification and examples be considered as exemplary only, with a true scope and spirit being indicated by the following claims and their full scope equivalents.

What is claimed is:

1. A computer-implemented method for creating a research tree, comprising:
receiving, by a processor, a query, the query specifying a search parameter for searching a document repository;
executing the query to search the document repository;
storing, in the data repository, the query and a result of the query as a root node of a research tree;
receiving, by the processor, a first request for a filter for the result of the query;
storing the first filter and information identifying a plurality of documents matching the first filter as a first filter node connected to the root node;
receiving a request to view a first document from the plurality of documents matching the first filter; and
storing the request to view the first document as a first document node connected to the first filter node.

2. The method of claim 1, further comprising creating information used to display the research tree, including the root node, the first filter node, and the first document node.

3. The method of claim 2, further comprising:
receiving a request to hide the first filter node from the display of the tree; and
creating information used to display the research map so that the root node is displayed and the first filter node and the first document node are hidden.

4. The method of claim 2, further comprising:
associating a client number with the root node of the research map;
receiving a client number; and
creating information used to display the research map when the client number associated with the root node matches the received client number.

5. The method of claim 2, wherein the display includes a plurality of research maps displayed in reverse chronological order.

6. The method of claim 1, further comprising:
receiving a request for a second filter for the results of the query; and
storing the second filter and information identifying a plurality of documents matching the first filter and the second filter as a second filter node connected to the first filter node.

7. The method of claim 6, further comprising:
receiving a request to view a second document from the plurality of documents matching the first filter and the second filter; and
storing the request to view the second document as a second document node connected to the second filter node.

8. The method of claim 7, further comprising:
creating information used to display the research map in a tree structure including the root node, the first filter node, the first document node, the second filter node, and the second document node.

9. The method of claim 1, further comprising:
receiving a request to view a third document cited in the first document; and
storing the request to view the third document as a third document node connected to the first document node.

10. The method of claim 6, further comprising:
receiving a request to delete the first filter node; and
creating a third filter node connected to the root node of the research map, the third filter node comprising the second filter node.

11. The method of claim 1, further comprising associating a note with the first document node.

12. The method of claim 1, further comprising sending the research tree to a second processor, wherein the second processor uses the root node, the filter node and the document node to recreate the research tree.

13. The method of claim 1, further comprising generating information used to print the research tree.

14. A computer-readable storage device storing instructions for creating a research tree, the instructions causing one or more computer processors to perform operations, comprising:
receiving a query, the query specifying a search parameter for searching a document repository;
executing the query to search the document repository; storing, in the data repository, the query and a result of the query as a root node of a research tree;
receiving a request for a first filter for the result of the query;
storing the first filter and information identifying a plurality of documents matching the first filter as a first filter node connected to the root node;
receiving a request to view a first document from the plurality of documents matching the first filter; and
storing the request to view the first document as a first document node connected to the first filter node.

15. The computer-readable storage device of claim 14, the operations further comprising creating information used to display the research tree, including the root node, the first filter node, and the first document node.

16. A system for creating a research tree, comprising:
a processor;
a memory coupled to the processor, the memory storing instructions to direct the processor to perform operations comprising:
receiving a query, the query specifying a search parameter for searching a document repository;
executing the query to search the document repository;
storing, in the data repository, the query and a result of the query as a root node of a research tree;
receiving a request for a first filter for the result of the query;
storing the first filter and information identifying a plurality of documents matching the first filter as a first filter node connected to the root node;
receiving a request to view a first document from the plurality of documents matching the first filter; and
storing the request to view the first document as a first document node connected to the first filter node.

17. The system of claim 16, the operations further comprising the operation of creating information used to display the research tree, including the root node, the first filter node, and the first document node.

18. The system of claim 16, the operations further comprising sending the research tree to a second processor, wherein the second processor uses the root node, the filter node and the document node to recreate the research tree.

19. The system of claim 16, the operations further comprising generating information used to print the research tree.

20. A computer-implemented method for searching a document repository using a research map, comprising:
generating information for displaying the research map, the information comprising a search node and a document node representing a document;
receiving, by a processor, a selection of one or more document nodes from the displayed research map; and
performing, by the processor, the operations of:
determining metadata values common to a majority of the documents represented by the selected document nodes,
determining a frequency with which the metadata values occur in the documents,
generating a search string comprising the metadata values,
performing a search of the document repository using the search string, and
generating information used to display one or more documents found as a result of the search.

21. The method of claim 20, further comprising:
creating a root node for a new research map from the search string and the results of the search.

22. The method of claim 20, wherein the search string represents a union of a predetermined number of the most frequently occurring metadata values.

23. The method of claim 20, wherein the search string represents a union of a selection of metadata common to a majority of the documents.

24. The method of claim 20, wherein the metadata comprises a plurality of categories of metadata.

25. The method of claim 24, wherein a weight is assigned to each category of metadata and the results generated from the search string for a category of metadata are prioritized using the assigned weight for each category.

26. The method of claim 24, wherein the search string is generated from a predetermined number of values of metadata in each category.

27. A system for searching a document repository using a research map, comprising:
a processor; and
a memory coupled to the processor, the memory storing instructions to direct the processor to perform operations comprising:
generating information for displaying the research map, the information comprising a search node and a document node representing a document,
receiving a selection of one or more document nodes from the displayed research map,
determining metadata values common to a majority of the documents represented by the selected document nodes,
determining a frequency with which the metadata values occur in the documents,
generating a search string that represents a union of a predetermined number of the most frequently occurring metadata values,
performing a search of the document repository using the search string, and
generating information used to display one or more documents found as a result of the search.

28. A computer-readable storage device storing instructions for searching a document repository using a research map, the instructions causing one or more computer processors to perform operations, comprising:
generating information for displaying the research map, the information comprising a search node and a document node representing a document;
receiving a selection of one or more document nodes from the displayed research map;
determining metadata values common to a majority of the documents represented by the selected document nodes;
determining a frequency with which the metadata values occur in the documents;
generating a search string based on a predetermined number of the most frequently occurring metadata values;
performing a search of the document repository using the search string; and
generating information used to display one or more documents found as a result of the search.

29. The computer-readable storage device of claim 28, the operations further comprising:
creating a root node for a new research map from the search string and the results of the search.

30. The computer-readable storage device of claim 28, wherein the metadata comprises a plurality of categories of metadata.

31. The computer-readable storage device of claim 30, wherein a weight is assigned to each category of metadata and the results generated from the search string for a category of metadata are prioritized using the assigned weight for each category.

32. The computer-readable storage device of claim 30, wherein the search string is based on the predetermined number of values of metadata in each category.

33. A computer-implemented method of searching a document repository using a research map, comprising:
generating information used to display a research map, the information comprising search nodes, filter nodes, and document nodes;
receiving a selection of a first filter node comprising a first document result list from a first research tree displayed in the research map;
receiving a selection of a second filter node comprising a second document result list from a second research tree displayed in the research map;
determining, by a processor, a third result list including documents from both the first document result list and the second document result list; and
generating data to display the third result list.

34. The method of claim 33, further comprising:
saving the third result list as a root node of a new research tree.

35. The method of claim 33, wherein the first research tree and the second research tree are the same research tree.

36. A computer-readable storage device storing instructions for searching a document repository using a research map, the instructions causing one or more computer processors to perform operations, comprising:
generating information used to display a research map, the information comprising search nodes, filter nodes, and document nodes;
receiving a selection of a first filter node having a first document result list from a first research tree displayed in the research map;
receiving a selection of a second filter node having a second document result list from a second research tree displayed in the research map;
determining a third result list including documents from both the first document result list and the second document result list; and
generating data to display the third result list.
